(19) United States
(12) Patent Application Publication
(10) Pub. No.: US 2021/0361113 A1
(43) Pub. Date: Nov. 25, 2021

(54) Equipment for grilling food

(71) Applicant: Modul Grill S.r.l., Monselice (IT)

(72) Inventor: Alessandro Regazzon, Monselice (IT)

(21) Appl. No.: 16/980,399

(22) PCT Filed: Feb. 20, 2019
(86) PCT No.: PCT/IB2019/051364

§ 371 Date: Sep. 13, 2020

(30) Foreign Application Priority Data
Feb. 1, 2019 (IT) 102019000001479

(51) Int. Cl. A47J 37/04; A47J 37/07; F24C 15/06; A47J 36/32

(52) U.S. Cl. CPC A47J 37/042; A47J 37/0745; F24C 15/08; A47J 36/321; F24C 15/06

(57) ABSTRACT

A piece of equipment for grilling food includes a frame that can be translated vertically and rotated by 180°, and is adapted to support several pairs of grates hinged to each other. A first motor causes the grate-holding frame to translate vertically and a second motor is configured to rotate the grate-holding frame.

The present patent concerns pieces of equipment used for grilling various types of meat, vegetables, cheeses, etc.

At present different types of grills in various shapes and sizes are known, more specifically very large grills are known, which are used for recreational and collective activities, for example on the occasion of fairs or village festivals, where it is necessary to grill large quantities of food of different types and sizes, such as: polenta, suckling pigs, meat, whole chickens, vegetables.

Said known large grills do not include devices for turning the meat, so that it is necessary to turn each single piece with a fork or another suitable tool.

When using those grills, cooks are forced to stand in close proximity to the heat source, even for a long time, with consequent overheating, burns and scalds due to the heat produced by the flames and/or the embers and the boiling oil that can also be sprayed outwards.

In addition to the risk of burns, it is also necessary to consider the hygienic aspect, since the persons around the grill sweat due to the strong heat generated by the fire and the embers, and the sweat may also come into contact with the food being grilled.

Furthermore, the cook, in order to turn the meat, tries to stand as far from the edge of the grill as possible, with consequent operating difficulties.

The known grills force the cooks to remain constantly alert, since they need to check the degree of cooking of each single piece being grilled, in order to evaluate its degree of cooking and thus decide whether it must be turned or not.

In order to overcome all the drawbacks described above, a new piece of equipment for grilling various types of food, such as meat, vegetables, polenta, etc. has been designed and carried out.

Said piece of equipment comprises, among its main parts, a grate-holding frame suited to rotate by 180° preferably on its center axis, in order to allow both sides of the piece of meat or food in general to be grilled alternately.

More specifically, the invention comprises a new grate-holding frame moved by at least two distinct motors having two different and distinct functions.

A first motor is designed to translate the grate-holding frame on the vertical plane, from bottom to top and vice versa, starting from a lower horizontal position located at a convenient distance for grilling the products in the best possible way.

A second motor is designed to make the grate-holding frame rotate on itself, in such a way as to allow the food to be cooked on both sides.

Thus, said first motor will serve to translate the grate-holding frame first upwards and then downwards, in such a way that in the position corresponding to the maximum height the grate-holding frame can be rotated by 180° on its center axis, thus inverting the side of the food facing downwards.

Said 180° rotation of the grate-holding frame on its axis is obtained by means of said second motor, which is made integral with the translating device that supports the grate-holding frame, in such a way that said second motor translates from a lower position to an upper position together with the grate-holding frame.

After the rotation of the grate-holding frame, the first motor will provide for translating the latter downwards, so that said overturned grate-holding frame returns to the ideal grilling position.

Said second motor can also serve the function of rotating the grate-holding frame with a continuous motion.

It is also possible to replace the grate-holding frame with a horizontal rod or rotisserie spit to be applied to the equipment, in such a way as to be able to grill whole animals (chickens, pigs, etc.), thanks to the second motor that is suited to make said spit rotate with a continuous motion.

In place of the grate-holding frame, it is also possible to insert a series of spits that are set rotating on their axis by means of said second motor, wherein suckling pigs or bigger animals are put on said spits.

Said equipment for grilling meat and other products furthermore comprises an electric and electronic control system equipped with at least one timer and some position sensors, so that it is possible to set the cooking time, the number of rotations, the position of the grate-holding frame with respect to the plane on which the embers lie, and wherein said position can be changed according to the quantity of heat, the temperature, the type of product to be grilled.

According to the invention, the timer can thus be set on a grilling time of just a few minutes or on much longer grilling times, which are necessary, for example, when grilling chickens.

Said control device, therefore, can include several cooking programs, according to the heat source and to the products to be grilled.

The piece of equipment can conveniently comprise also a remote control, or any other wireless control device, so that all the operations, including the start of the two motors, can be preset and controlled from a distance of a few meters, which makes the work of the persons in charge less demanding.

The equipment comprises a grate-holding frame that rotates on its center axis thanks to said second motor, and wherein said grate-holding frame is divided in several zones designed to support pairs of grates, each made up of two grates or grids hinged to each other.

Each of said pair of grates is constrained to said grate-holding frame rotated by said second motor, wherein several zones designed to support said pairs of grates are defined in said frame.

Each of said pairs of grates described above comprises a first grate, or first grid, and a second grate hinged to said first grid, in such a way that said second grate hinged to said first grate can be opened and spaced from the latter in order to be able to hold in position food products having also different thicknesses.

The connection hinges between said second grates and said first grate may allow the rotation axis to be changed, so that the grates are rotated in several, more or less spaced positions, according to the size of the food product being cooked.

As a consequence of the above, it will be necessary to approach the grate-holding frame exclusively in order to extract the pairs of grates or to insert or extract the food in/from the first row of double grates, wherein said operation can be carried out with the grate-holding frame in a position in which it is partially lifted and partially rotated with respect to the grilling position, which is less demanding for the cook.

At the end of the grilling process, one or more pairs of grates are extracted in order to move the food away from the heat source or it is possible to open all or some of the second upper grates in order to extract the food contained therein. Successively, it will be possible to introduce other food and to start a new grilling cycle.

Furthermore, the grate-holding frame can be replaced with a rotisserie spit or multiple spit in order to roast the food by making it rotate continuously, without interruptions, by means of the second motor.

The equipment for grilling food can comprise a heat source consisting of one or more plates with gas burners located under them, wherein said gas burners can be adjusted by means of a control unit that is described below.

Said gas plates can be fed with methane gas or any other suitable gas.

Said gas plates guarantee increased safety, as there are no sparks produced by the embers, and they also ensure more control over the heat source, since it is possible to vary the intensity of the flame in different positions of the grill.

Alternatively, said equipment for grilling food can use embers contained in an underlying steel drawer as a heat source.

Said drawer containing the embers will be positioned exactly under the grate-holding frame, so that it is in a suitable position for correctly grilling the food.

Said embers must be distributed homogeneously inside the drawer, in such a way that the heat is evenly distributed over the entire surface of the grill.

Said equipment for grilling food furthermore comprises side and rear safety shields, suited also to prevent the ejection of sparks from the drawer containing the embers and protect the embers themselves in case of wind.

The rotary grill's moving device will preferably be of the type with chain, wherein the chains are protected by suitable casings.

Said grilling equipment may also comprise a front door suited to close also the front part of the grill, meaning the part where the person who places the food on the grill works.

Said front door can be constituted by two front panels or doors, which will be coupled with the right and left sides of the structure.

Said equipment for grilling food may also comprise wheels located at the base and intended to allow the grill to be moved more easily.

The invention includes also a control unit for the new device.

Said control unit will manage all the grilling operations, such as the translation and rotation of the grill, the adjustment of the gas burners, the opening and closing of the front shield, etc., thus allowing the cooks to remain at a safety distance.

Said control unit emits and/or manages also acoustic and/or light signals intended to signal to the operators the various grilling stages and to warn them that the food is ready to be extracted.

Said control unit comprises several cooking cycles that can be used according to the type of food to be grilled.

The characteristics of the invention are illustrated in greater detail in the following description, with reference to the drawings that are attached hereto by way of non-limiting example.

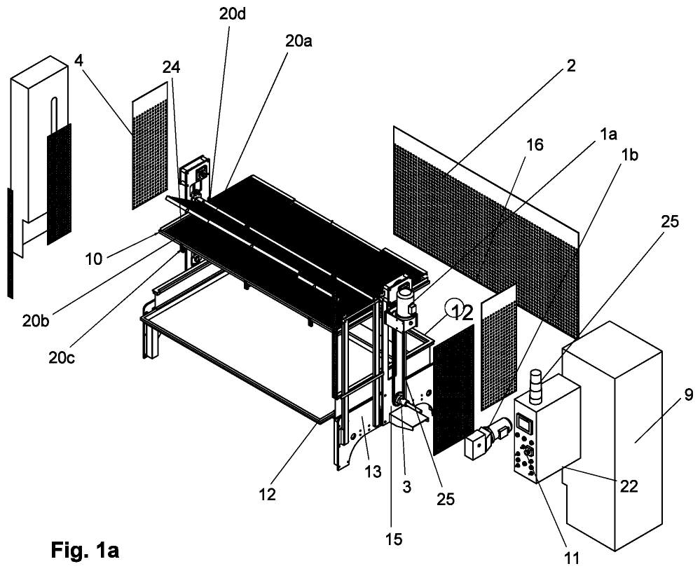

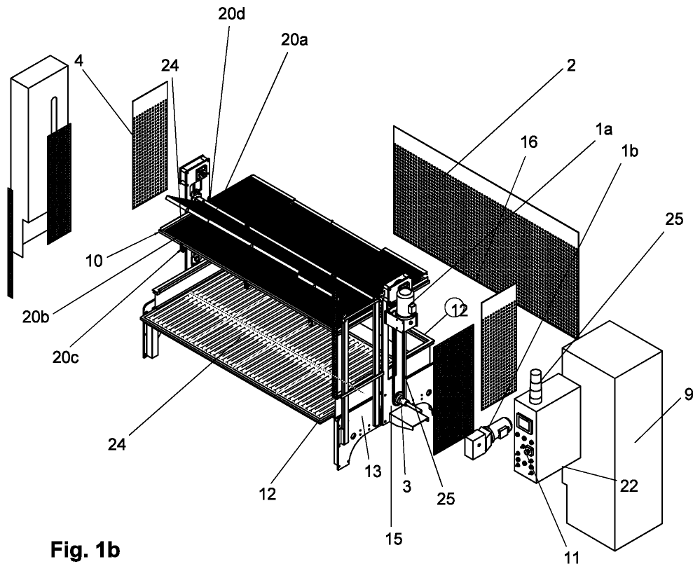

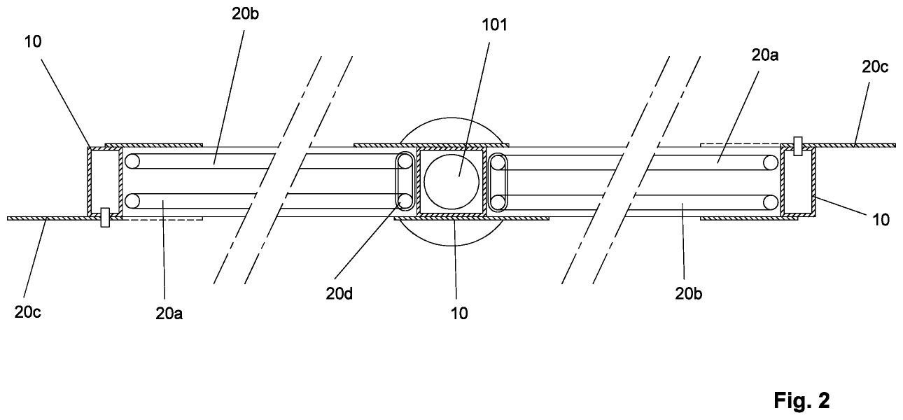

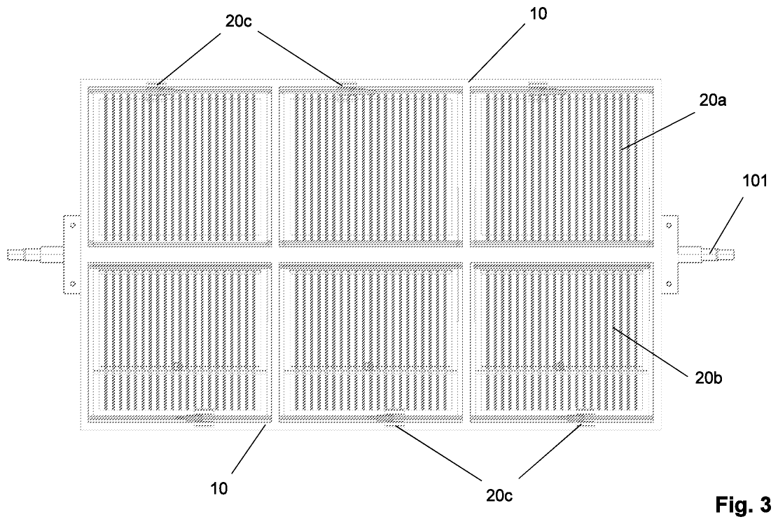

FIGS. 1a and 1b, 2, 3 show the grilling equipment in its main parts:
grate-holding frame divided in eight sectors (10);
first motor (1b) for the translation of the grate-holding frame (10) and second motor (1a) for the rotation of the same;
vertical motion transmission unit (3);
protective shield (2) located in the rear part of the grate-holding frame (10);
uprights (15) for the vertical translation of the motor (1a) dedicated to the rotation of the grate-holding frame (10) with several double grates (20a, 20b);
protective shields (4) located at the sides of the grilling area;
drawer (9) suited to contain and protect the transmission members;
double grates (20a) and (20b);
upper grates (20b) suited to contain and hold the food and hinged to the first grate (20a);
translating and rotating grate-holding frame (10) with double grates (20a) and (20b);
emergency switch (11);
element designed to contain the heat source (12), embers (FIG. 1a) or gas plates (24) (FIG. 1b);
equipment supporting base (13);
upright (15) for the grill translation chain;
safety micro switch (16) positioned on the rear shield (2);
PLC connection support;
locking device (20c) for the double upper (20a) and lower (20b) grates that hold the food in position;
upper grate (20a);
hinges (20d) for the rotation of the double upper (20a) and lower (20b) grates;
PLC control system;
gas plates (24);
grill translation chain (25).

More specifically, always in FIGS. (1a) and (1b) it is possible to observe that the equipment for grilling food comprises, among its main parts, two side supports (13) equipped with vertical elements or uprights (15) with supporting legs and a grill bearing shoulder, said two side supports being connected and made integral with each other by a drawer (ember-holding 12a, plate-holding 12b) in such a way as to obtain a stable structure.

Each of said side supports (13) comprises a guide for the sliding movement of the translation unit of the grate-holding frame (10) and of the end of the center shaft of the frame itself.

The first motor (1b) for the vertical translation of the grate-holding frame (10) is applied to the transmission unit (3), which provides for activating the chain (25) on which the translating support of the center shaft of the grate-holding frame (10) itself is fixed.

Said center shaft of the grill will be connected to the second motor (1a) which translates vertically together with the frame (10) with grates (20a, 20b) and provides for the 180° rotation of the frame itself.

Around the drawer (12) there are side shields (4) and rear shields (2) designed both to protect the grill from the wind and to prevent the operators from approaching the grill from the wrong side.

Said first grate (20a) and said second grates (20b) are hinged to each other by means of one or more hinges (20d) that allow the variation of the rotation axis of each grate with respect to the other, while special coupling and fixing devices (20c) allow the pair of grates to be constrained to the frame (10).

In this case the grate-holding frame comprises eight sectors, each suited to contain hinged pairs of grates (20a, 20b) that are independent of each other, in such a way that it is possible to open even one sector only, in which the food, owing to its characteristics, may have a cooking time different from that of the food positioned in the other sectors.

In addition to the main mechanical parts described above, the grilling equipment comprises also a unit for controlling and managing the cooking times and stages, provided with an emergency switch (11).

The operation of the grilling equipment includes the lowering of the grate-holding frame (10), the introduction of the food in the various sectors, the closing of the second grates (20b), following which the food is compressed and held in the correct position.

The grilling process includes several rotations of the grate-holding frame (10), in such a way that the food can be heated on both sides; more specifically, several intervals are preset for all the grill rotation and translation operations.

The grate-holding frame (10), with the pair of grates (20a, 20b) closed, is lifted in horizontal position by means of the first motor (1b) and reaches the upper position, where the second motor (1a) provides for its 180° rotation. Successively, the first motor (1b) moves the grill back to the optimal grilling position and this operation is repeated at regular intervals with preset duration and for the preset number of steps.

The whole management of the grill movement is preset by the control unit (22), which provides for managing all the operations, allowing the cooks to remain at a safety distance.

At the end of each preset grilling cycle, an acoustic and/or light signal will be activated to warn the operators that the food is ready to be extracted. All or just some of the upper grates are opened, so that the food contained therein can be extracted. Successively, it will be possible to introduce other food and a new grilling cycle can be started.

Protection casings for the moving members are provided.

These are the schematic outlines which are sufficient for the expert in the art to carry out the invention, consequently on practical application variants may be developed which do not affect the substance of the innovative concept introduced herein.

Therefore, with reference to the above description and the attached drawings, the following claims are expressed.

The invention claimed is:

1. Equipment for grilling food, comprising:
at least two vertical uprights (15) equipped with guides for a vertical sliding movement of a grate-holding frame (10) supporting one or more pairs of grates (20a and 20b);
said grate-holding frame (10), which is configured to translate in a vertical direction and to rotate;
one or more pairs of grates (20a, 20b) hinged to each other, made integral with said grate-holding frame (10) and configured to be opened to receive the food and closed to hold the food during rotation and grilling;
a first motor (1b) configured to provide for a vertical translation of said one or more pairs of grates (20a, 20b);
a second motor (1a) configured to rotate said grate-holding frame (10) and translating vertically along guides of said vertical uprights (15);
a control system (22) configured to provide for a cyclical translation and rotation of said grates; and
a heat source placed under said gate-holding frame (10) and said grates (20a, 20b).

2. The equipment according to claim 1, further comprising one or more gas plates (24) operating as a heat source.

3. The equipment according to claim 1, further comprising one or more lower elements (12) adapted to contain embers as providing a heat source.

4. The equipment according to claim 1, wherein said grate-holding frame (10) is divided in a plurality of sectors on which two or more pairs of grates (20a, 20b) can be rested and constrained.

5. The equipment according to claim 1, further comprising a PLC control system (22) configured to control the cyclic translation and rotation of said grate-holding frame (10) according to preset time intervals.

6. The equipment according to claim 1, wherein said one or more pairs of grates (20a, 20b) comprise upper and lower grates hinged to each other with rotation hinges (20d) between said upper grates (20a) and said lower grates (20b), and wherein said rotation hinges comprise two or more rotation points, thus making it possible to vary a distance of the lower grates (20b) from the upper grates (20a).

7. The equipment according to claim 1, further comprising, as a protection element for the heat source, at least one rear shield (2), side shields (4), and a door in a front part of said equipment, said at least one rear shield, said side shield, and said front door being configured to close the equipment on each side after insertion of the food.

8. The equipment according to claim 1, further comprising a heat probe configured to control a temperature of the heat source, wherein said probe is connected to said PLC.

9. The equipment according to claim 1, further comprising two or more wheels at a base of said equipment, said two or more wheels being configured to allow a translation of the equipment.

10. The equipment according to claim 1, further comprising an emergency switch (11) to be used to stop any movement of the equipment or to off the heat source.

11. The equipment according to claim 1, further comprising light-emitting devices (25) configured to warn an operator that the equipment is working and to provide information regarding a cooking process.

12. The equipment according to claim 1, further comprising control devices that allow a complete rotation of the grate-holding frame only when the grate-holding frame is in a completely lifted position.

13. The equipment according to claim 1, further comprising a remote control configured to set and/or control all grilling stages, including a start of the first and the second motors, from a suitable distance.

14. The equipment according to claim 1, wherein said grate-holding frame (10) is configured to be replaced with a rotisserie spit in order to cook entire animals.
